(19) United States
(12) Patent Application Publication
(10) Pub. No.: US 2007/0090242 A1
(43) Pub. Date: Apr. 26, 2007

(54) Top & bottom mount, heavy load supporting, girder clamp system

(76) Inventor: William F. Gulley, Monroe, LA (US)

Correspondence Address: C. EMMETT PUGH, 82 N. MAIN ST., SUFFIELD, CT, 06078-2102, US

(21) Appl. No.: 11/246,433

(22) Filed: Oct. 7, 2005

(51) Int. Cl. G09F 7/18

(52) U.S. Cl. 248/228.1

(57) ABSTRACT

A clamping system (10/110) for holding, supporting or lifting a heavy work piece (200; e.g. a pipe section of pipe line of hundreds of pounds) located below a girder (100) using rigging (210) attached to the clamp at attachment openings (27/37, 127/137) equally spaced from the center-line web (103) of the girder, which clamping system is attached to opposed, side edges of the top flange member (102) of the girder (vis-a-vis the bottom flange member 101), or in a second embodiment (FIGS. 9+) to either the top or the bottom. In the second embodiment a straight bar (150) with a series of spaced, locking cavities (151a/b) is used in place of the threaded rod, threaded engagement of the first embodiment, with the cavities working with spring-biased pin latches on the side gripping elements. When used on the bottom flange, a slidable, load supporting, centrally located accessory (160) is used.

### REFERENCE TO RELATED APPLICATION

This application is a substitute application of previously pending patent application Ser. No. 10/404,177 filed Mar. 31, 2003, which in turn was a substitute application of Ser. No. 09/675,964 filed Sep. 29, 2000 of the same title hereof, which in turn was a continuation-in-part application of then pending patent application Ser. No. 09/435,139, filed Nov. 5, 1999 entitled “Top-Mount, Heavy Load Bearing, Girder Clamp System,” the disclosures of which are incorpo-rated herein by reference. It is noted that FIGS. 1-8 hereof and the relevant written description below are taken from the first filed application, while FIGS. 9+ and the relevant written description are added in the second filed, continuation-in-part application, which is substantively identical to the instant application. No claim under 35 USC 120 is made based on any of these application and no co-pendency exists. These prior filings are relevant to showing earlier dates of constructive reduction to practice of the invention.

### TECHNICAL FIELD

The present invention is directed to a heavy load bearing, clamping system and associated methodology which in the first embodiment is attached to the top (not the bottom) of a girder or “I” beam and in the second embodiment can be attached to either the top or the bottom (with an added accessory) of the girder or “I” beam, both being for use in handling a heavy load (e.g. a heavy pipe section for a pipe line weighing hundreds of pounds) suspended from the top-mount clamping system below the girder.

In the first, exemplary, embodiment of the invention, the clamping system includes two, side gripping elements, one of which has a threaded interior, for placement on opposite sides of the top, side extensions or flanges of the girder, with a threaded rod member extending between them, along with an optional, opposed pair of lower, attached but moveable, side support pieces which are pushed out and set against the central or web piece of the girder for enhanced support. To install the clamping elements, the two gripping elements are positioned on opposite sides of the top girder flange with the threaded rod positioned between them, with one gripping element merely riding on the rod set against the head of the rod and the other in threaded engagement with the threads of the rod. The threaded rod member then is rotated in the screwing-in direction, causing the threaded gripping element to be drawn toward the other, non-threaded element, until they lock unto the top sides and edges of the top part of the girder, while concurrently or sequentially the side support pieces are set and locked into place against the side web surfaces of the beam, strongly anchoring the clamp to the top of the I-beam or girder.

To release the clamp system of the first embodiment, the threaded rod is rotated in the reverse direction, causing the two side gripping members to become further spaced apart, allowing them, along with the side support pieces to be removed from the beam for further use in another installation. When the clamping system is attached to the top of the girder, one or more heavy load support members are attached to either or preferably both of the side gripping members and used to, for example, hold, suspend and/or lift heavy loads located below the bottom of the beam and attached by a flexible sling or cable or other line and/or rigging element to the load support member(s).

In the second, exemplary, currently preferred embodiment of the invention, the clamping system includes two, substantively identical, side gripping elements for placement on opposite sides of the top (or bottom), side extensions or flanges of the girder, with the two, side gripping elements riding in telescoping or straddling, nested fashion on a straight bar having a series of spaced, locking or latching indentations or cavities at both ends of the bar. Each side gripping elements includes a spring-biased latch into a selected one of which cavities the spring-biased latch is latched, on opposite sides. To install the clamping elements, the two gripping elements are slidingly positioned on opposite sides of the top (or bottom) girder flange at opposite ends of the bar. After one side gripping element is latched at or toward its respective end of the bar against or near one side of the girder flange using its respective spring-loaded latch mating with one of the cavities at its end, the other element is slid in against the other, opposite side of the girder flange, and it is then locked in place using its respective spring-loaded latch mating with a selected one of the cavities at its respective side of the bar. Thus, the side gripping elements are lock unto the top (or bottom) sides and edges of the top (or bottom) part of the girder, while concur-rently or sequentially the side support pieces or elements are set and locked into place against the side web surfaces of the beam, strongly anchoring the clamp to the top (or bottom) of the I-beam or girder. When the second embodiment is used on the bottom flange, a load bearing accessory unit is added to the central area of the bar upon which it initially slidingly rides, in similar fashion to the side gripping elements, but is fixedly locked into place under the central portion of the girder when the two, side gripping elements are latched into place against the sides of the bottom flange.

Each of the side gripping elements includes a load bearing support plate with a hole through it for use in attaching and supporting loads typically hung off either one or preferably both of the load bearing plate holes when the clamp system is affixed to the top of the girder, while the centrally located, load bearing accessory preferably is used for attaching a heavy load when the clamp system is affixed to the bottom of the girder, although, even in this latter case, the side load bearing holes still could be used, if so desired.

To release the clamp system of the second embodiment, at least one of the spring-loaded latches is pulled out, allowing at least that one of the two, side gripping elements to be slidingly removed off of its respective end of the bar, then allowing the rest of the clamp elements to be removed from the girder, allowing for their further use in another installation.

Like the first embodiment, when the clamping system of the second embodiment is attached particularly to the top of the girder, one or more heavy load support members are attached to either or preferably both of the side gripping members and used to, for example, hold, suspend and/or lift heavy loads located below the bottom of the beam and attached by a flexible sling or cable or other line and/or rigging element to the load support member(s). The attachment to the top girder approach allows for the maximum amount of clearance, while the second embodiment's approach with its central load supporting accessory element still provides improved clearance in comparison to the prior art.

### BACKGROUND ART

Slings for lifting and carrying heavy pipes or other objects are known (see, for example, applicant's U.S. Pat. No. 5,688,011 entitled “Lifting Sling System Having Single Strap With Size-Varying, Spaced, In-Line Eye Loops” issued Nov. 18, 1997 and pending application Ser. No. 08/972,761 entitled “Lifting Sling System With Spaced, Bi-Directional Loops” filed Nov. 18, 1997, being issued as U.S. Pat. No. ______ on ______ Date (the disclosures of which are incorporated herein by reference for further general background information). The present invention allows one to, for example, attach such slings to the top or bottom flanges of beams and girders for, for example, greater or at least improved “head-room” or clearance in very close and tight spaces.

In contrast to the approach of the first embodiment of the present invention, which is designed to be preferably used only on the top flange of the girder, lifting or carrying clamps in the prior art have been designed and used to attach to a beam to lift another object attached on the bottom flanges which causes one to loose the significant “head-room” needed to make certain lifts. Also the present invention is very compact, in comparison to clamps of the prior art, which are much larger, causing one to loose even more headroom when making lifts. The object of the first embodiment of the present invention is to provide a clamping device that will attach to the top flanges of I-beams and girders (the two terms being considered equivalent within the context of the present invention), giving maximum headroom for making a lift, while also providing a compact device that will allow one to attach it in spaces where, for example, clamps of the prior art cannot be used.

Additionally, the preferred embodiment of the present invention allows one to make lifts without, for example, welding temporary lugs or steel in place where headroom is needed, as has been done in the prior art.

A list of prior patents which may be of some general interest, although it is noted that some of them are not from the field to which the present invention pertains, is provided below:

| Patent No. | Inventor(s) | Issue Date |
|---|---|---|
| 14,260 | Dietrich | 1917/02/20 |
| 2,675,201 | Friel | 1954/04/13 |
| 2,916,244 | Renfroe | 1959/12/08 |
| 3,124,330 | Robinson | 1964/03/10 |
| 3,632,152 | Renfroe | 1972/01/04 |
| 4,541,155 | Gagnon | 1985/09/17 |
| 4,563,109 | Ortemond | 1986/01/07 |
| 4,799,639 | Riley | 1989/01/24 |
| 4,826,113 | Winters | 1989/05/02 |
| 5,029,670 | Whitmer | 1991/07/09 |
| 5,249,769 | Griek et al | 1993/10/05 |
| 5,711,397 | Flora et al | 1998/01/27 |
| 6,076,633 | Whitmer | 2000/06/20 |

As shown from the foregoing patents, the broad concept of providing opposed, side gripping members held together by a threaded rod for attaching to the side edges of a girder flange goes back at least as early as 1916 (note the Dietrich U.S. Pat. No. 14,260). However, there are significant structural and application differences between the present invention and the Dietrich device, and it is particularly noted that the Dietrich device clamps to the lower end or bottom of the I-beam, which, inter alia, decreases the available head-room for suspending or lifting loads from the clamp, a problem which the present invention is designed to over-come.

U.S. Pat. Nos. 2,675,201, 2,916,244, 4,541,155, 4,799,639 and 6,076,633 are exemplary of other forms of clamping devices which clamp to the bottom flange of an I-beam, some of which are not from the field to which the present invention pertains. Note is made particularly of the '155 patent, which appears to be for the same sort of purpose as the present invention and has some structural elements having some similarity to those of some of the parts of the present invention, but the present invention likewise structurally works in an innovatively different manner, and there also are innovative structural and methodological differences as well.

U.S. Pat. Nos. 3,124,330, 3,632,152 4,563,109, 4,826,113 and 5,711,397 are exemplary of various type of systems which at least in part do attach to the upper or top flange of an I-beam. The '330 patent suspends scaffolding and the like located to the side of the beam and not a heavy load suspended from a flexible line down below the beam; while the '113 patent supports a pipe line on top of an I-beam. The '152 patent is directed to a hinged clamp used to lift the I-beam itself and not use the I-beam as a base structure as in the present invention.

The '109 patent uses a hinged clamp to suspend I-beams from other structural support beams on an offshore platform. The '397 patent is directed to a safety device for steelworkers who are working way up in the air on I-beams (note FIG. 1).

The U.S. Pat. No. 5,249,769 patent was cited merely for general background information.

With respect to the approach of the second embodiment of the present invention, perhaps the Flora U.S. Pat. No. 5,711,397 and the Whitmer U.S. Pat. No. 6,076,633 patents are the most interesting patents, although it is noted that neither the “safety device for steel-workers” of the Flora patent or the “personnel safety device” of the Whitmer patent is from the field of invention to which the present invention pertains, which is directed to a heavy load supporting clamp system used for supporting and moving heavy loads of hundreds of pounds and more, such as heavy pipe sections and the like.

Thus, with respect to both embodiments' approaches, there are significant, “unobvious” differences in application or use of the system of the present invention, as well as in some of the invention's structural details and approaches, in comparison to those of the prior art.

### GENERAL SUMMARY DISCUSSION OF INVENTION

A primary object of the first embodiment of the lifting device of the present invention is to provide a device to be attached to the top flanges of I-beams and girders, which in the context of the present invention are considered equivalent terms, to lift or otherwise hold a heavy load located below the girder, while the primary object of the second embodiment of the clamping system of the present invention is to provide an improved device which can be used to clamp to either the top or the bottom flanges of I-beams or girders, while using an accessory device in the latter.

It is also an object of the present invention to provide a system that will allow heavy materials and equipment to be lifted to a higher elevation, preferably without welding temporary lugs or steel in place to make these lifts.

Another object of the present invention is to provide a device that will attach to the top flanges of beams and girders in spaces when clamps of the prior art cannot be attached because of their design.

A further object of the present invention is to save time by not having to install temporary lifting lugs or steel and also to save the cost of these materials and the man hours that it would require to put these temporary materials in place and to remove them when the job is complete.

The present invention allows one to make lifts in areas that devices of the prior art cannot because of how the clamp of the invention attaches to the beam and its compact size [e.g., extending up a maximum of only about two (2″) inches or less above the top of the girder). Also, if required, the exemplary device of the present invention can remain in place as a permanent support if, for example, a “hot work” permit could not be obtained in the area being worked.

It is a further of the second embodiment of the invention to provide a clamping system that can be alternatively attached to either the top or the bottom flanges of a girder adding relatively little reduced “head-room” even when used on the bottom flange.

To achieve these objectives, the present invention provides a heavy load bearing, clamping system and associated methodology which is attachable to the top (or alternatively the bottom for the second embodiment) of a girder or “I” beam, as well as preferably the central or intermediate, vertical web member of the girder (in the case of a variant of the first embodiment), for use in handling a very heavy load (e.g. a heavy pipe section for a pipe line weighing hundreds of pounds) suspended from the top-mount clamping system.

In the exemplary, first embodiment of the invention, the clamping system includes two, side gripping elements, one of which has a threaded interior serving as a drive engagement mechanism, for placement on opposite sides of the top, side extensions or flanges of the girder, with a threaded rod member serving as a mechanical drive extending between them and across the top of the girder. Additionally, in a variant of the first embodiment of the invention, there is also provided an opposed pair of lower, attached but moveable, side support pieces which, after the side gripping clamp elements are installed, are pushed out and set against the central, web piece of the girder and locked in place for enhanced support.

The tops and sides of the side-gripping clamp elements, the threaded rod and the lower, supplemental support bars (1^{st} embodiment) form together a rectangular gripping structure about the top flange of the girder. Additionally, most, if not all, of the engagement between the clamp elements and the top flange and intermediate web member of the girder are straight line, flat, face-to-face engagements. This arrangement all enhance and add to the gripping strength of the clamping system about the top of the girder.

The tops of the clamp elements in both embodiments extend up in combination a maximum of about two (2″) inches or less for compactness and use in tight places above the girder (note, e.g., the application shown in FIG. 2).

To install the first embodiment of the side clamping elements, the two gripping elements are positioned on opposite sides of the top girder flange with the threaded rod then positioned between them bridging across the top of the girder, with one gripping element merely riding on the rod set against the bolt-type head of the rod and the other in threaded engagement with the threads of the rod. The threaded rod member then is rotated in the screwing-in direction, causing the threaded gripping element to be driven or drawn toward the other, gripping element, until they lock unto the top sides and edges of the top part of the girder, while concurrently or sequentially the side support pieces are locked into place against the opposed, side web surfaces of the beam.

To release the clamping system of the first embodiment, the threaded rod is rotated in the reverse or screwing-out direction, causing the two, side gripping members to become further spaced apart, allowing them, along with the side support pieces, to be easily removed from the beam for further use in another installation.

Other drive mechanisms beside the more preferred threaded rod and the mating, threaded bore are possible, but the threaded rod & threaded bore approach for a mechanical drive mechanism is currently preferred in the first embodiment due to its compactness, strength, simplicity and economy and ease of manufacture. With respect to its compactness, due to the centralized location of the rod and the use of an internal, threaded bore, the over-all clamp system of the preferred embodiment only adds a practically de minimis added height of, for example, one and seven-eighths (1⅞″) of an inch, and a maximum of about two (2″) inches is highly desirable. Likewise, the use of a centralized rod and a square block with internal, mating threads having at least a flat bottom at the area that it contacts the top of the top flange of the girder greatly enhances the over-all strength of the rectangular clamping configuration of the 1^{st} embodiment.

In the second, exemplary, currently preferred embodiment of the invention, the clamping system includes two, substantively identical, side gripping elements for placement on opposite sides of the top (or bottom), side extensions or flanges of the girder, with the two, side gripping elements riding in telescoping or straddling, nested fashion on a straight bar having a series of spaced, locking or latching indentations or cavities at both ends of the bar. Each side gripping elements includes a spring-biased pin latch with its pin lockingly inserted into a selected one of the cavities or holes to which the respective spring-biased pin latch is latched, on opposite sides.

To install the clamping elements of the 2^{nd} embodiment, the two gripping elements are slidingly positioned on opposite sides of the top (or bottom) girder flange at opposite ends of the bar. After one side gripping element is latched at or toward its respective end of the bar against or near one side of the girder flange using the pin of its respective spring-loaded latch mating with a selected one of the cavities or holes at its end, the other element on the other side is slid in against the other, opposite side of the girder flange, and it is then locked in place using its respective spring-loaded latch mating with a selected one of the cavities or holes at its respective side of the bar. Thus, the side gripping elements are lock unto the top (or bottom) sides and edges of the top (or bottom) part of the girder, while concurrently or sequentially the side support pieces or elements are set and locked into place against the side web surfaces of the beam, strongly anchoring the clamp to the top (or bottom) of the I-beam or girder.

When the 2^{nd} embodiment is used on the bottom flange, a load bearing support accessory unit is added to the central area of the straight bar upon which it initially slidingly rides, in similar fashion to the side gripping elements, but is fixedly locked into place under the central portion of the girder when the two, side gripping elements are latched into place against the sides of the bottom flange. The accessory element preferably is relatively narrow and includes a “vertically” extended slot of a length into which a grappling hook can be easily inserted. Although it use on the bottom of the girder reduces some of the “head-room,” it adds relatively little in comparison to the prior art of the field to which the present invention pertains.

As in the 1^{st} embodiment, each of the side gripping elements includes a load bearing support plate with a hole through it for use in attaching, supporting and moving heavy loads typically hung off either one or preferably both of the load bearing plate holes when the clamp system is affixed to the top of the girder, while the centrally located, load bearing support accessory preferably is used for attaching a heavy load when the clamp system is affixed to the bottom of the girder, although, even in this latter case, the side load bearing holes still could be used, if so desired.

To release the clamp system of the 2^{nd} embodiment, at least one of the spring-loaded latches' pin is pulled out of its mating cavity or hole, allowing at least that one of the two, side gripping elements to be slidingly removed off of its respective end of the bar, then allowing the rest of the clamp elements to be removed from the girder from the other side, allowing for their further use in another installation.

Like the 1^{st} embodiment, when the clamping system of the 2^{nd} embodiment is attached particularly to the top of the girder, one or more heavy load support members are attached to either or preferably both of the side gripping members and used to, for example, hold, suspend and/or lift heavy loads of many hundreds of pounds located below the bottom of the beam and attached by a flexible sling or cable or other line and/or rigging element to the load support member(s). The attachment to the top girder approach allows for the maximum amount of clearance, while the 2^{nd} embodiment's approach with its central load supporting accessory element still provides improved clearance in comparison to the prior art.

In both embodiments, when the clamping system of either embodiments is attached to the top flange member of the girder, one or more heavy load support members are attached to the side gripping members and used to, for example, hold, suspend and lift heavy loads (e.g., a pipe line section of pipe) located below the girder attached by, for example, a flexible sling or cable or other line and/or other mechanical rigging as part of the load support member(s).

Accordingly, the present invention in both of its embodiments provides a device for holding and/or lifting a very heavy work piece located below a girder using the top flange member of a girder and also a device to hold and support a work piece permanently from the top of a girder, if desired. Alternatively, the approach of the 2^{nd} embodiment with its load supporting accessory could be used for attachment to the bottom flange member.

It is thus an object of the present invention to provide a method of holding and/or lifting heavy objects of at least hundreds of pounds in weight from one elevation to another using as the clamping surfaces at least in substantial part the sides of the top flange member (or alternatively the bottom flange member) of a structural beam which is at a higher elevation than the object to be lifted, which object is located below the girder.

Additionally, it is highly desired and likewise highly preferred that the over-all clamping system include heavy load attachment members or holes on both sides of the I-beam or girder, equally spaced with respect to the longitudinal center-line (i.e., the girder's central web member) of the girder, with the heavy load (e.g. a heavy pipe section of hundreds of pounds or more) being supported substantially equally from both sides and below the bottom flange of the girder (as in the manner illustrated in FIG. 1). Such an arrangement balances out the forces on both sides of the girder, substantially reducing, if not eliminating, any twisting torque or moment on the upper parts of the clamping system, as well as on the girder's top flange. Alternatively, in the 2^{nd} embodiment's attachment to the bottom flange member, a centrally located accessory element can be used to achieve the same stable results.

The above and other objects and features of the present invention will become apparent from the drawings, the description given herein, and the appended claims.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 is a side view (looking down the length of the “I” beam or girder) of the exemplary, first embodiment of the top-mount, heavy load bearing, beam clamping system of the present invention used particularly when, for example, heavy pipe lines run through areas where low headroom creates a problem for installing and using a support or hanger following the approaches of the prior art, noting particularly that the clamping members are attached to the top flange member of the beam and not the bottom, as in the prior art.

FIG. 2 is a side view (looking perpendicular to the side of the “I” beam or girder) of the exemplary embodiment of the clamp system of FIG. 1, but this time being installed between floor decking of an upper floor and the steel beam which holds up the particular floor.

FIG. 3 is a side, close-up view of the exemplary, 1^{st} embodiment of the clamp system (similar in perspective to FIG. 1 but from the opposite side) as attached to the top flange of the girder, as in FIGS. 1 & 2 but without showing the other application elements of either FIG. 1 or 2.

FIGS. 4A & 4B are close-up, side and end views, respectively, of one of the exemplary clamp gripping elements, namely, the smooth bore one, of the exemplary, 1^{st} embodiment of the clamping system of FIGS. 1-3; while

FIGS. 5A & 5B are close-up, side and end views, respectively, of the other, exemplary threaded, clamp gripping elements, namely, the threaded one, of the exemplary clamping system of FIGS. 1-3.

FIGS. 6A & 6B are close-up, side and end views, respectively, of the exemplary supplemental, lower, supporting or anchoring element of the exemplary clamping system of FIGS. 1-3.

FIG. 7 is a close-up, side view of the exemplary threaded, driving rod element of the exemplary clamping system of FIGS. 1-3.

FIG. 8 is a close-up, plan view of the exemplary washer element of the exemplary clamping system of FIGS. 1-3.

FIG. 9 is a side view of a second, alternative, currently preferred embodiment of the clamping system of the present invention, with the cavities or holes in the bar shown as in cross-section, with the basic clamping system elements installed on the top flange of a girder, in similar fashion to the 1^{st} embodiment's FIG. 3; while

FIG. 9A is an end view thereof.

FIG. 10 is a side, exploded view of the clamping elements of the 2^{nd} embodiment of FIG. 9, with the cavities or holes in the bar shown as in cross-section; while

FIG. 11 is a bottom, exploded view of the clamping elements of the 2^{nd} embodiment of FIG. 9, that is, FIG. 11 is similar to FIG. 10 but is a bottom view of the elements rather than a side view.

FIG. 12 is a side view of a second, alternative, currently preferred embodiment of the clamping system of the present invention, with the cavities or holes in the bar again shown as in cross-section, installed on the bottom flange of a girder.

FIG. 13A is an end view of the load bearing supporting accessory element used when the clamping system of the 2^{nd} embodiment is attached to the bottom flange, as in FIG. 12; while

FIG. 13B is frontal or side view thereof.

FIG. 14 is a close-up detailed, side view of the spring-biased pin latch used in the 2^{nd} embodiment of the clamping elements of FIGS. 9-13B.

FIG. 15 is an enlarged view of the 2^{nd} embodiment, substantively identical to FIG. 9, but enlarged and with exemplary dimensions added.

FIG. 16 is an enlarged view of the accessory element of the 2^{nd} embodiment when used for attachment to the bottom flange member of a girder, substantively identical to FIG. 13B, but enlarged and with exemplary dimensions added.

### EXEMPLARY MODES FOR CARRYING OUT THE INVENTION

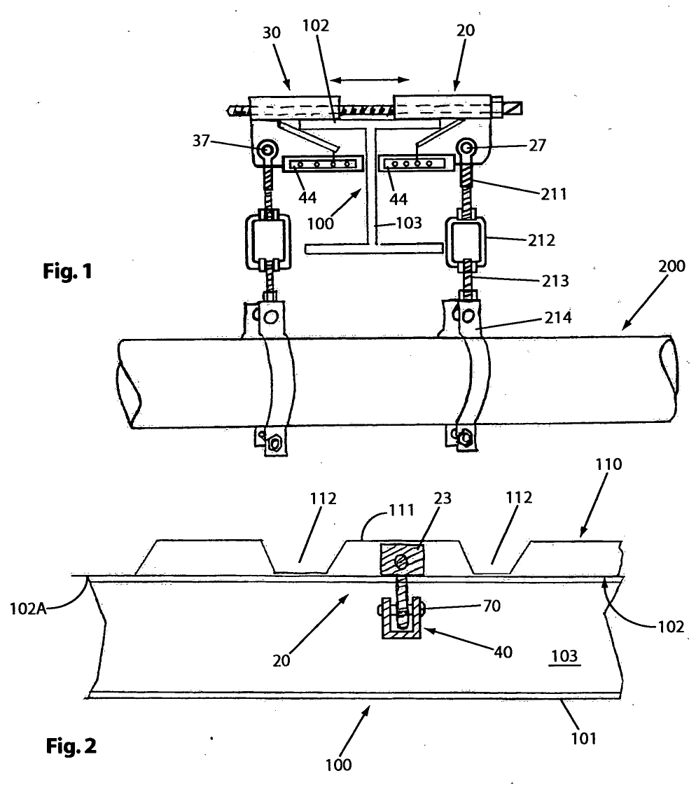

### Initial, 1^{st} Embodiment (Top Flange Member Connection Only; FIGS. 1-8)

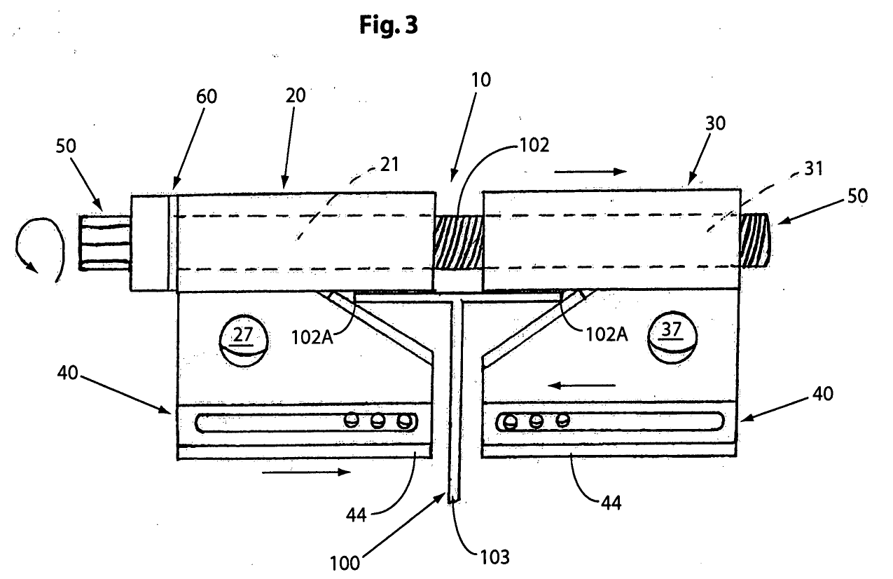

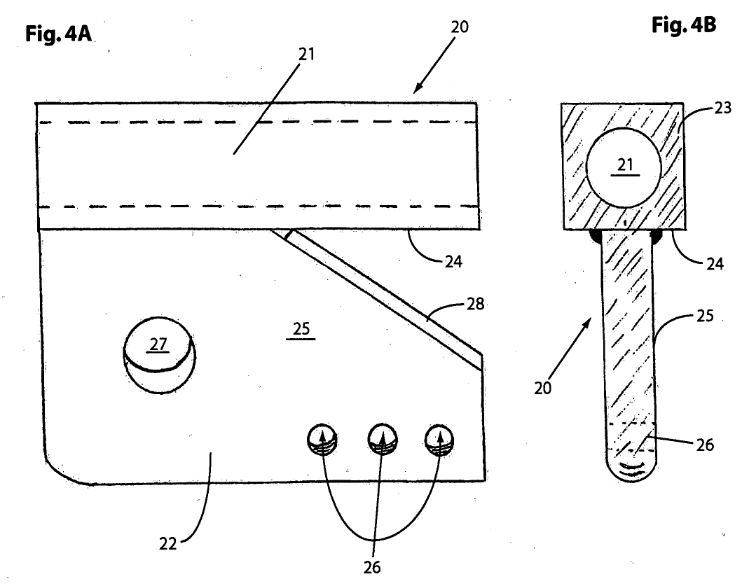

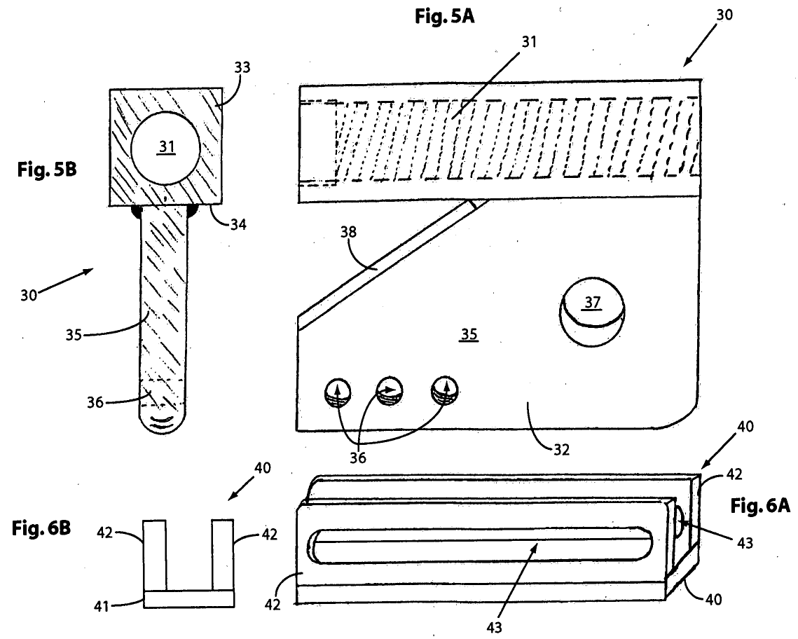

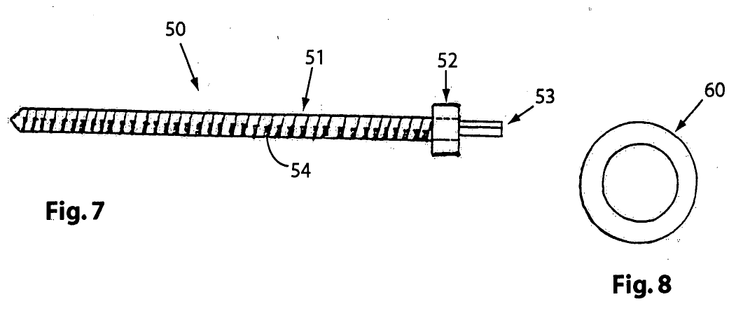

Referring now to the drawing, and in particular to FIGS. 3-8, the exemplary, 1^{st} embodiment of the over-all clamp system of the present invention is designated generally by the numeral 10 and is made of the following basic parts:
a first, side-gripping or engaging, clamping element 20 having a smooth, longitudinally extended, end-to-end bore 21 (FIGS. 4A & 4B);
a second, side-gripping or engaging, clamping element 30 having a threaded, longitudinally extended, end-to-end bore 31 (FIGS. 5A & 5B);
two, supplemental, lower, supporting or anchoring elements 40 (FIGS. 6A & 6B), one for the bottom or lower end 22 of side gripping element 20 and the other for the lower end 32 of the other, side gripping element 30; and
a threaded, driving rod element 50 (FIG. 7), which in use will be inserted through the smooth bore of the first clamp element and an associated washer element 60 (FIG. 8), along with a set of standard nut and bolts for attaching the anchoring elements 40 to the bottoms of the side clamp gripping elements 20 & 30.

FIGS. 1 & 2 show the elements of the clamping system 10 in use attached to the top flange of a structural I-beam or girder 100, typically made of steel, as used in the field in two exemplary applications, explained more fully below.

The first, side-gripping clamp element 20 can be made of, for example, carbon steel material having a top formed by a top block 23 having dimensions of, for example, one and three fourths inches deep by two inches wide by six inches long (1.75″×2″×5.75″). Affixed to the bottom 24 of the top block 23 is a downwardly extending plate 25 having exemplary dimensions of, for example, three fourths of an inch by three inches by five and three fourths inches (0.75″×3″×5.75″), with the top block 23 and the bottom plate 25 being affixed by, for example, welding them together.

The bottom plate 25 includes a series of, for example, three-eights (⅜″) inch, spaced bolt holes 26 along its forward bottom edge for attaching and fixing the supplemental, support and anchoring members or elements 40. Likewise a somewhat outboard, more centrally located, hoist attachment hole 27 [e.g. a seven-eights (⅞″) hole] in included for attaching a loading bearing connector 210 (note FIG. 1).

At its girder contacting surface is another, small, plate 28 welded to the beam flange engagement edge of the bottom plate 25 presenting an exemplary thirty (30°) degree, downward taper, having exemplary dimensions of one fourths of an inch by two and one half inches by four inches (0.25″×2.5″×4″). This angularity allows the clamping elements 20 (30) to be used with various sizes of I-beams or girders.

The internal, end-to-end bore 21 is drilled through the full length of the top block 23 without any threads to allow the side gripping clamping element 20 to rest and move freely on the threaded body 51 of the threaded rod 50 as it is rotated to move the other gripping clamp element 30 with respect to the first gripping clamp element 20 for adjusting the effective width of the clamp 10.

The other, very similar, side, gripping clamp elements 30 likewise includes a basic top body block 33, a bottom plate 35 attached to the top block's bottom 34, with attachment holes 36 and 37, and a flange engagement plate 38. This second, side-gripping clamping element 30 can be identical in size and construction to the first, side-gripping element 20, except that the bore 31 is threaded for affirmatively engaging with the threads on the threaded body 51 of the threaded rod 50 to be affirmatively driven in and out with respect to the head 25 as the rod is rotated (note circular and straight direction lines in FIGS. 1 & 3). Thus, the top block 33 has been drilled and taped to accept and interface with the threads 54 of the threaded rod 50, which can be, for example, a one (1″) inch standard, “off-the-shelf” threaded rod.

The threaded rod 50 can be, for example, a one(1″) inch “B-7″ grade (high grade for strength) rod twenty two (22″) inches in length. The rotatable, threaded rod 50 serves as a drive to drive or draw the two side-gripping elements 20/30 together or apart, depending on how the drive is actuated or rotated. Attached to one end is a threaded nut 52 (welded from the back) to allow only one side to be pulled by the threads. Also welded to the nut 52 is, for example, a three fourth hex head 53 for a standard three fourth socket wrench to allow quick connecting.

Washer 60 can be a standard, steel, flat washer to fit the exemplary one (1″) inch rod 50. The washer reduces friction while the clamp 10c is being adjusted by rotating the rod 50. The washer 60 does not play any part in the strength of the clamp.

The supplemental support or anchoring members 40 each comprise a base plate 41 [e.g., a quarter inch by one inch by five inches (0.25″×1″×5″) plate] and two, affixed, parallel, side plates 42 [e.g., two, like, quarter inch by one inch by five inches (0.25″×1″×5″) plate] forming an elongated, “U” shaped member (note FIG. 6B). As can best be seen in FIG. 6A, each side plate 42 includes along its length a slot 43 through which fastening bolts can be inserted. The pair of support members or bars 40 fit over the bottom edge portions of the bottom plates 25/35, respectively, and can be moved along them, with their final position fixed in place by nuts & bolts sets 70.

Thus, a set of standard nuts and bolts 70 are used with the holes 26/36, and such nuts/bolts are well known and hence are not illustrated in detail. After the clamping members or elements 20/30/50/60 are placed in clamping engagement with the upper or top flange 102 of the beam 100, the supplemental support and anchoring members 40 are pushed out until their leading edges 44 engage the central, vertically disposed web part 103 of the I-beam or girder 100. The anchoring members 40 are then locked into positioned, causing the members 40 to become load bearing members, taking some of the load back to the beam web 103. This locking is achieved by placing nuts/bolts 70 through the slots 43 and the holes 26/36, with at least the heads of the bolts, if not also the nuts extending past the widths of the slots, serving like set screws or locking bolts. Washers can be included on the nuts and/or bolts if so desired.

When all of the clamping elements 20/30/40/50/60 are all placed in clamping and supporting engagement with the upper or top flange 102 and the central web 103 of the beam 100, the over-all clamping structure forms a box-like or rectangular arrangement as can best be seen in FIG. 1, with a substantial amount of flat, face-to-face type engagement between the leading portions of the flat bottoms 24 of the side elements 20/30 and the flat, leading surfaces 44 of the side supplemental support members 40 with the flat surfaces of the top flange 102 and the web 103 of the girder 100 which are contacted by the clamp system. These characteristics provide great structural strength for attaching and bearing directly or indirectly heavy loads weighing in the hundreds of pounds or more. This approach represents a very valuable contribution to “the useful arts.”

Additionally, as can be seen in FIG. 1, it is highly desired and likewise highly preferred that the over-all clamping system 10 include heavy load attachment members or holes 27/37 on both sides of the I-beam or girder 100, equally spaced with respect to the longitudinal center-line of the girder, with the heavy load 200 (e.g. a heavy pipe section of hundreds of pounds or more) being supported substantially equally from both sides and below the bottom flange 101 of the girder. Such an arrangement balances the forces on both sides of the girder 100, substantially reducing, if not eliminating, any twisting torque or moment on the upper parts 20/30/50 of the clamping system 10, as well as on the girder's top flange 102.

It should be noted that, in the exemplary, 1^{st} embodiment of the invention, the clamp system's top blocks 23/33 only extend up above the top of the girder 100 about one and seven-sixteenths (1 7/16″) of an inch, providing a very compact clamping system requiring very little height above the girder top to be used. Additionally, by being attached to the top flange 102 of the girder 100, the clamp system 10 adding very little to the height of the girder (e.g., only about two inches maximum) for enhanced, effective “head room” to work on and suspend the load 200 below th girder. This approach likewise represents a very valuable contribution to “the useful arts.”

Of course, all of the dimensions and configurations and parts described above and illustrated in detail are subject to great variation, although the size of the top (23/33) of the side clamping members (20/30) should be kept within a maximum height of about two (2″) inches or less.

Also, a family of clamping systems might be provided for different sizes or classes of I-beams or girders or for varying heavy load bearing capacities.

Some additional, exemplary but not exclusive variations include the broadening out of the flange engaging plates 28/38 so that they extend further out laterally in their engaging contact with the side edges of the top flange 102 of a beam, adding to the side-to-side stability of the clamping system. Many other mechanical features or approaches could be used in place of the exemplary ones described; for example, rather than use a spaced set of holes 26/36 and locking nuts & bolts 70, the supplemental support members (analogous to 40) could be driven out with a screw thread or rack and pinion arrangements or they could be attached to the side clamping elements by pivots, allowing them to be swung in into contact with the central web 103 and then locked in position; or, rather than engage in face-to-face engagement with the sides of the central web as illustrated, the leading edges (analogous to 43) of the support members could be engaged with the intersection of, for example, the central web and the lower flange 101 and anchored to them. Additional or substitute, supplemental support or anchoring (vis-a-vis the bars 40) could be obtained by also interfacing the over-all clamp system (10) with the bottom flange 101, if so desired, but the primary clamping support strength preferably is still obtained off of the top girder flange 102.

For further exemplary variations, the side clamping elements 20/30 could have their bottom plates 25/35 made wider than the width of the top block 23/33, although the relative configurations shown in FIGS. 5B & 6B are currently preferred for greater load bearing strength. Additionally, rather than using a threaded rod drive arrangement, a rack and pinion or other track drive, etc., could be used.

As previously noted, two exemplary applications for the use of the clamping system 10 of the present invention are illustrated in FIGS. 1 & 2. As is well know, an I-beam or girder 100 includes a, laterally extended, bottom flange member 101 and a laterally extended, top flange member 102 joined together by a vertically disposed, central web member 103 which defines the longitudinal center-line of the girder. Such girders are used throughout commercial and industrial construction and are well known.

In FIG. 1 a heavy load comprising a heavy section 200 of pipe line is being held up by the clamping system 10 clamped to the top flange 102 and the central web 103 of the girder 100. Using the somewhat centrally located, outboard holes 27/37, the load 200 is suspended from each side of the clamping system 10 by exemplary shackle rigging 210, including a threaded clevis rod 211, a central turn buckle 212 and a lower, threaded clevis rod 213, culminating in holding pipe brackets or clamps 214 which encircle the pipe section 200. By using the illustrated, standard pipe clamps and components attached to the top mount beam clamp system 10, the load support can be installed without any significant problem. Also, no “hot work permits” typically would be required to install this support, which permits some times are hard to get issued.

FIG. 2 shows the clamp 10 in clamping position attached between the decking 110 of the floor and the support beam 100. As is known for such an application, a series of spaced girders 100 (one being shown for simplicity purposes) support the undulating floor decking 110 having sequential, upper plateaus 111 and lower valleys sections 112 running cross-wise (usually orthogonally) above the spaced girders and supported by the girders, with the valley sections resting on the upper flanges 102 of the girders and the plateaus being about just a couple of inches or more above the girders.

In the preferred methodology of the 1^{st} embodiment of the present invention, the side-gripping elements 20/30 are placed on the top flange 102 of the girder 100 between two valleys 112 and below a plateau 111 of the floor decking 110. It is believed that the clamp system 10 of the present invention is the only clamp known at this time that can be installed in such a tight area and carry out the job of lifting heavy work pieces of hundreds of pounds and more located below the girder with the heavy load 200 attached to the clamping system substantially equidistantly on both sides of the girder 100.

Of course, the above described, two applications of FIGS. 1 & 2 are only exemplary, and many other uses and applications of the clamping system of the present invention are possible.

Thus, in summary, the method of the exemplary embodiment of the present invention comprises the following steps:
(a) providing a clamp system 10 for the top flange member 102 of an I-beam type girder 100 having a bottom flange member 101, a top flange member 102 and an intermediate, central web member 103 between them, with the clamp system including two, side gripping clamp elements 20/30 having side bearing areas 28/38 for engaging the side edges 102 A of the top flange of the girder, a threaded rod 50 extended between them in threaded engagement with one (30) of the side-gripping elements, with each of the side-gripping elements having a side engaging element 40 for being locked in engagement with the central web portion of the girder;
(b) positioning the two, side gripping elements on opposite sides of the top girder flange with the threaded rod then positioned between them, with one gripping element merely riding on the rod and the other in threaded engagement with the threads of the rod;
(c) rotating the threaded rod member in the screwing-in direction, causing the threaded gripping element to be drawn toward the other, until they lock unto the top side edges of the top part of the girder, while concurrently or sequentially the side support pieces 40 are locked into place against the side web surfaces of the beam;
(d) attaching a heavy load 200 weighing at least hundreds of pounds by two, typically identical sets of rigging members 210 on both sides of the girder, one on each side of the girder, with one attached to one of the side gripping elements and the other attached to the other of the side-gripping elements at points substantially equally spaced from the longitudinal center-line of the girder with the heavy load positioned below the girder, suspending the heavy load below the girder.

To release the clamping system, the threaded rod 50 is rotated in the reverse or screwing-out direction, causing the two side gripping members 20/30 to become further spaced apart, allowing them, along with the side support pieces 40 to be removed from the beam for further use in another installation.

When the clamping system 10 is attached to the top flange member 102 of the girder 100, one or more heavy load support or rigging members 210 are attached to the side gripping members 20/30 and used to, for example, hold, suspend and lift heavy loads 200 (e.g., a pipe line section of pipe) attached by a flexible sling or cable or other line and/or other rigging 210 to the load support hole(s) 27/37 equidistantly disposed on opposite sides of the girder web member 103.

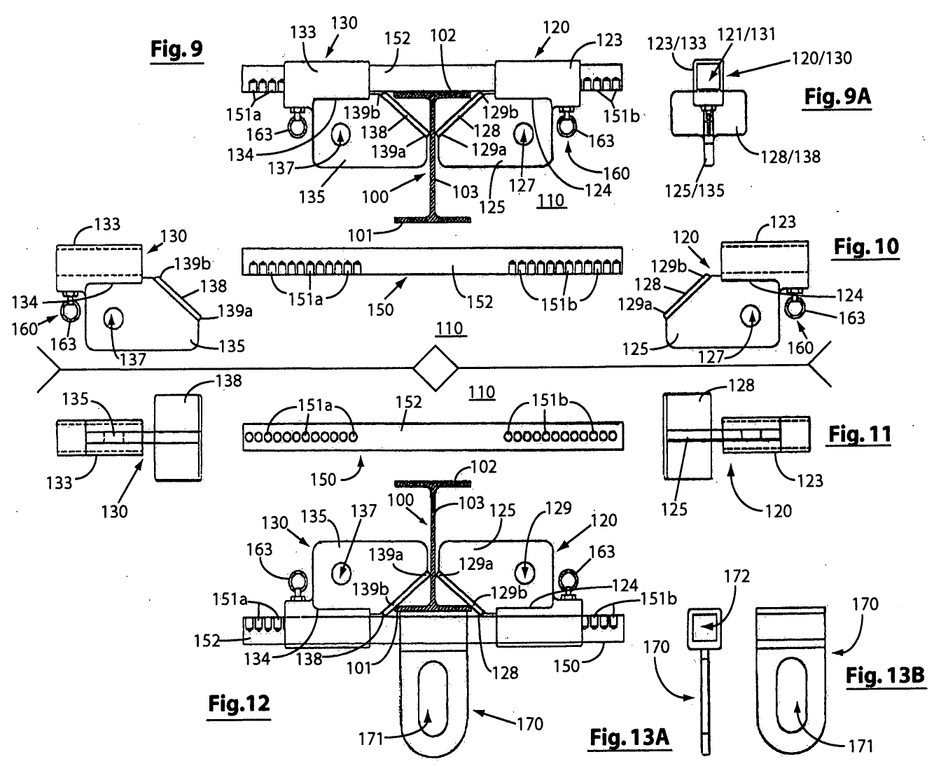

It is noted that the foregoing discussion in connection with FIGS. 1 & 2 are analogously applicable (with the exception of the threaded member 50 and its use) to the use of the 2^{nd} embodiment of the clamping elements described in detail below, particularly when they are connected to the top flange member 102 as in FIG. 9.

### 2^{nd} Embodiment (Both Top/Bottom Flange Member Connections; FIGS. 9+)

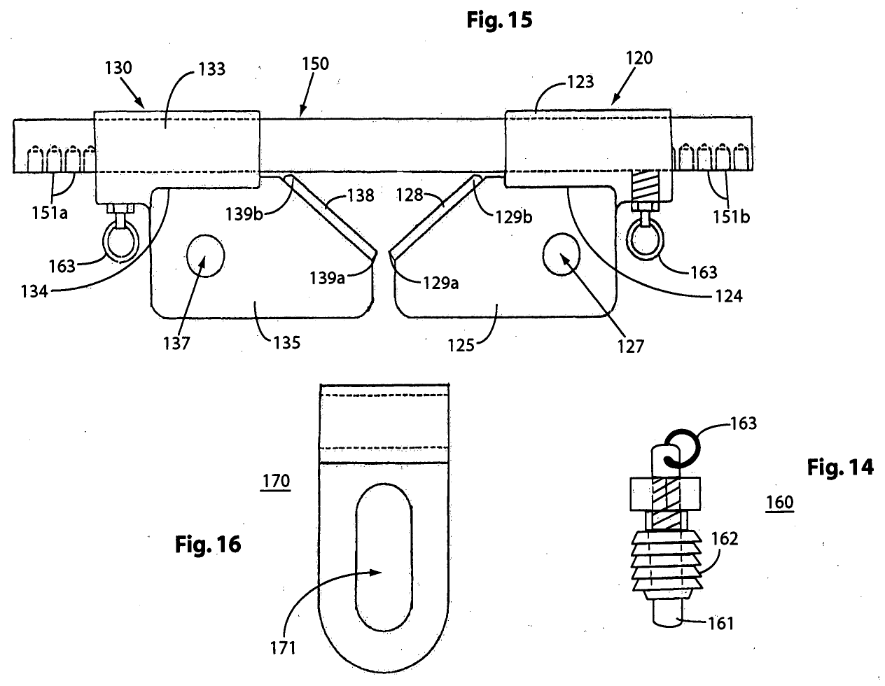

Referring now to the drawings, and in particular to FIGS. 9+, the exemplary, currently preferred, 2^{nd} embodiment of the over-all clamp system of the present invention is designated generally by the numeral 110 and is made of the following basic parts:
a first, side gripping, clamping element 120 having a spring-biased pin latch 160 with a latching pin 161 (note FIG. 14);
a second, substantively identical, side gripping, clamping element 130 likewise shaving a spring-biased pin latch 160 with a latching pin 161;
a straight bar element 150 with two series of spaced, cavities or holes 151a & 151b located at opposite ends of the bar, respectively, with the cavity holes being designed to mate with the pins 161 of the spring-biased pin latches 160; and
a centrally located, load bearing support element 170 having a vertically extended, slot 171 for attaching selected heavy loads and/or rigging.

FIG. 9 show the elements of the clamping system 110 in use attached to the top flange of a structural I-beam or girder 100, typically made of steel, as used in the field in two exemplary applications, explained more fully above in connection with FIGS. 1 & 2.

The first, side gripping clamp element 120 (130) can be made of, for example, carbon steel material having a top block 123 (133) having dimensions of, for example, one and three fourths inches deep by about two inches wide by four and a half inches long (1.75″×2″×4.5″). Affixed to the bottom 124 (134) of the top block 123 (133) is a downwardly extending. load bearing support plate 125 (135) having exemplary dimensions of, for example, three eighths of an inch thick by three and a quarter inches high [to the bottom 124 (134) of the top block 123 (133)] by six inches wide (⅜″×3.25″×6″), when viewed from the perspective of FIG. 9, with the top block 123 (133) and the bottom plate 125 (135) being affixed together by, for example, welding them together.

At its girder contacting surface is another, laterally extending plate 128 (138) welded to the beam flange engagement edge of the bottom plate 125 (135) presenting an exemplary thirty-nine (39°) degree, downward taper, having exemplary dimensions of, for example, one fourths of an inch by two and one half inches by four inches (0.25″×2.5″×4″). This angularity allows the clamping elements 120 (130) to be used with various sizes of I-beams or girders having varying flange member widths.

An internal, end-to-end, hollow, central area 121 (131) is formed through the full length of the top block 123 (133) to allow the side gripping clamping element 120 (130) to rest, slide and thereby move freely on and along the extended bar body 152 of the bar 150 for adjusting the effective width of the clamp 110, that is, the effective separation distance between the side gripping elements 120/130 as measured at the contact lines between the plates 128/138 and the side edges of the top flange member 102 (or 101 when configured for use as in FIG. 12).

As should be understood, the two, side-gripping elements 120 and 130 are substantively identical, a relationship which adds to the cost effectiveness and flexibility of application of the present invention. In essence one can be traded out for the other.

The extended bar or rod 150 can be, for example, a one and a quarter (1.25″) inch square “B-7” grade (high grade for strength) rod twenty (20″) inches in length. The latching cavities or holes 151a/151b can be, for example, three-eighths (⅜″) of an inch deep with a diameter of a half (0.5″) inch to mate will with a three-eighths (⅜″) pin 161 in the spring-biased pin latch 160.

As can best be seen in FIG. 14, the spring-biased pin latch 160, serving as a pin engaging mechanism, is affixed to the top block 123 (133) and includes an outer, surrounding spring 162 which biases the pin 161 out in its extended disposition. A finger pull ring 163 is included for pulling the pin 161 back from its extended disposition to, for example, pull the pin out of a selected cavity hole 151a/151b with which it had been engaged in a male/female manner, freeing up its respective side clamping element 120 or 130 for free movement along the bar 150. Such spring-biased pin latches are well know and are available “off-the-shelf” from a number of sources.

The laterally extended bar 150 serves as a connecting and locking member for the two, side gripping clamping elements 120/130 and as a carrier for the accessory element 170, described more fully below, when the clamping system is attached to the bottom flange 101 of the girder 100. When the side-engaging or gripping elements 120/130 and the accessory element 170 are telescopically moved or slid over the exterior surface of the bar 170, the bar serves as a track for each of them.

FIG. 12 show the elements of the clamping system 110 in use attached to the bottom flange member 101 of a structural I-beam or girder 100. It should be clear from comparing FIGS. 9 & 12 and the foregoing written specification, that the basic clamping system elements 120/130/150 are the same in both applications, with the latter, bottom flange application having the clamping elements flipped upside down.

However, when clamped to the bottom flange member 101, a supplemental, load bearing, downwardly extending, accessory element 170 (also see FIGS. 13A & 13B) having a hollow opening 172 through its length to telescopically mate with and about the periphery of the bar 150, similar to the hollow central region 121/131 of the side clamping elements 120/130 (note FIG. 9A), is also used. The accessory element 170 includes a “vertically” longitudinally extended slot having a length of, for example, three (3″) inches and a width of one and a half (1.5″) inches. The over-all length can be, for example, seven (7″) inches, with a over-all width of three and a half (3.5″) inches. As with respect to the other dimensions contained herein, they are subject to great variation.

When all of the clamping elements 120/130/150/170 are installed on the bottom flange member 101, the centrally located accessory element 170, centrally located directly below the central web member 103, is compressively locked into place, between the flat, bottom surface of the bottom flange member 101 and the flat, upper surface of the bar 150, and no longer can move from side to side (when viewed from the perspective of FIG. 12). Although the use of the accessory element 170, hanging down from and below the bottom flange member 101, does decrease the available “head-room,” it only adds about six to seven (6-7″) inches, in comparison to the typically fourteen (14″) inches or more of the prior art, bottom flange clamps.

When all of the clamping elements 120/130/150/160 are all placed in clamping and supporting engagement with the upper or top flange 102 (or the lower or bottom flange member 101) and the central web 103 of the beam 100, the over-all clamping structure forms a box-like or rectangular arrangement as can best be seen in FIGS. 9 & 12, with
a substantial amount of flat, face-to-face type engagement between the underside of the flat bar body 152 and the upper surface of the flange member 102 (or the bottom flange member 101 as in FIG. 12), and
the flat, leading edge surfaces 129a/139b and the flat, following or trailing edge surfaces 129b/139b of the lateral, orthogonal plates 128/138 with the corresponding flat surfaces of the central web member 103 and the top flange 102, respectively, of the girder 100 which are contacted by the clamping system elements. These characteristics provide great structural strength for attaching and bearing directly or indirectly heavy loads weighing in the hundreds of pounds or more. This approach represents a very valuable contribution to “the useful arts.”
   Thus, it should be understood that each of the orthogonal plates 128/138 has a sufficient length, taking into account their angularity, that allow its leading edge to contact the sides of the central web member 102 as its trailing edge contacts the side edge of the flange member 101 or 102 to which the clamping system is being attached.

Additionally, as should be understood from FIG. 1, it is highly desired and likewise highly preferred that the over-all clamping system 110 include heavy load attachment members or holes 127/137 of, for example, an inch (1″) in diameter, on both sides of the I-beam or girder 100, equally spaced with respect to the longitudinal center-line of the girder, with the heavy load 200 (e.g. a heavy pipe section of hundreds of pounds or more) being supported substantially equally from both sides and below the bottom flange 101 of the girder. Such an arrangement balances the forces on both sides of the girder 100, substantially reducing, if not eliminating, any twisting torque or moment on the upper parts 120/130/150 of the clamping system 10, as well as on the girder's top flange 102.

It should be noted that, in the exemplary, currently preferred embodiment of the invention, the clamp system's top blocks 123/133 only extend up above the top of the girder 100 about one and seven-sixteenths (1 7/16″) of an inch, providing a very compact clamping system requiring very little height above the girder top to be used. Additionally, by being attached to the top flange 102 of the girder 100, the clamp system 110 adds very little to the height of the girder (e.g., only about two inches maximum) for enhanced, effective “head room” to work on and suspend the load 200 below the girder. This approach likewise represents a very valuable contribution to “the useful arts.”

Of course, all of the dimensions and configurations and parts described above and illustrated in detail are subject to great variation, although the size of the top (123/133) of the side clamping members (120/130) should be kept within a maximum height preferably of about two (2″) inches or less.

Also, a family of clamping systems of the type of the 2^{nd} embodiment might be provided for different sizes or classes of I-beams or girders or for varying heavy load bearing capacities.

Some additional, exemplary but not exclusive variations include the broadening out of the flange engaging plates 128/138 so that they extend further out laterally in their engaging contact with the side edges of the web girder member 103 and the top flange 102 of a beam, adding to the side-to-side stability of the clamping system. Many other mechanical features or approaches also could be used in place of the exemplary ones described.

As noted above, the application details shown in FIGS. 1 & 2 are analogously applicable to the 2^{nd} embodiment of FIGS. 9+, particularly when used to clamp to the top flange member of a girder, and for brevity's sake will not be repeated here. Additionally, similar rigging and heavy load supporting and moving techniques can be used with respect to the 2^{nd} embodiment when it is used for attachment to the bottom flange member 101, as in FIG. 12, with the “vertically” elongated slot opening 171 (also see FIGS. 12 & 13B) of the accessory element 170 used for the main support and the support plates 125/135 and their respective holes 127/137 used, if so desired, for supplemental or alternative heavy load support. This further adds to the flexibility and usefulness of the present invention, particularly when used in the form of the 2^{nd} embodiment.

It is noted that the embodiments described herein in detail for exemplary purposes are of course subject to many different variations in structure, dimension, design, application and methodology. Because many varying and different embodiments may be made within the scope of the inventive concept(s) herein taught, and because many modifications may be made in the embodiments herein detailed in accordance with the descriptive requirements of the law, it is to be understood that the details herein are to be interpreted as illustrative and not in a limiting sense.

What is claimed is:

1. A heavy load bearing clamp system for holding up a heavy work piece of at least hundreds of pounds from and below an I-beam type girder having a top, laterally extended flange, a bottom, laterally extended flange and an intermediate, vertically disposed member forming the “I” of the girder, comprising:
a drive; and
two, associated, side-gripping elements, at least one of which having a drive engaging mechanism for interfacing with said drive, said two, side-gripping elements being placeable on opposite sides of the top flange of the girder, with said drive being extended between said two, side-gripping elements in driving engagement with at least one of said side-gripping elements at said drive engaging mechanism when said side-gripping elements are positioned on opposite sides of the top flange, said drive causing said two side-gripping elements to be drawn together to grip the side edges of the top flange between them when actuated, the heavy work piece being held up at least in part by at least one of said side-gripping elements from the top flange of the girder below the bottom flange of the girder.

2. The clamp system of claim 1, wherein:
at least one of said side-gripping clamp elements includes an inwardly moveable, supplemental support member moveable into engagement with the intermediate web member of the girder and capable of being locked into its engagement disposition.

3. The clamp system of claim 2, wherein there is a supplemental support member on both of said side-gripping clamp elements, and wherein:
said side-gripping clamp elements, said drive and said supplemental support members from a rectangular, surrounding structure about the top flange of the girder.

4. The clamp system of claim 1, wherein each of said side-gripping clamp elements includes:
a top placeable above the top of the top flange and having a height no more than about two (2″) inches, allowing the clamp system to be used in small compact areas above the girder.

5. The clamp system of claim 4, wherein:
said top of each of said side-gripping clamp has a flat bottom at least at its area in contact with the top of the top flange of the girder providing flat, face-to-face engagement therewith.

6. The clamp system of claim 4, further including:
an attachment selectively attaching a threaded nut to allow only one side to be pulled by the threads of said threaded rod.

7. The clamp system of claim 6, wherein there is further included:
a hex head welded to said attachment for being engaged with a standard socket wrench to allow quick connecting to said threaded rod for rotating it.

8. The clamp system of claim 1, wherein the girder has a longitudinal center- line, and wherein:
the heavy work piece located below the bottom flange of the girder is held up by both of said side-gripping elements from the top flange of the girder; and
wherein there is further included:
two load connection members, one on one of said side-gripping elements and the other on the other of said gripping elements, spaced substantially equally apart on opposite sides of the longitudinal center-line of the girder.

9. The clamp system of claim 1, wherein there is further included:
one or more of the other, innovative, unobvious structural features disclosed in the foregoing specification.

10. A method of lifting a heavy work piece located below an I-beam girder, comprising the following steps:
a) providing a clamp system (10) for the top flange member (102) of the I-beam type girder (100) having a bottom flange member (101), a top flange member (102) and an intermediate, central web member (103) between them with the girder having a longitudinal center-line, with the clamp system including two, side gripping clamp elements (20/30) having side bearing areas (28/38) for engaging the side edges (102A) of the top flange of the girder, a threaded rod (50) extended between them in threaded engagement with one (30) of the side-gripping elements, with each of the side-gripping elements having a side engaging element (40) for being locked in engagement with the central web portion of the girder;
(b) positioning the two, side gripping elements on opposite sides of the top girder flange with the threaded rod then positioned between them and located over and across the top girder flange, with one gripping element merely riding on the rod and the other in threaded engagement with the threads of the rod; and
(c) rotating the threaded rod member in the screwing-in direction, causing the threaded gripping element to be drawn toward the other, until they lock unto the top side edges of the top part of the girder, while concurrently or sequentially the side support pieces (40) are locked into place against the side web surfaces of the beam;
(d) attaching a heavy load (200) weighing at least hundreds of pounds by two sets of rigging members (210) on both sides of the girder, one set on each side of the girder, with one attached to one of said side gripping elements and the other attached to the other of said side-gripping elements at points substantially equally spaced from the longitudinal center-line of the girder with the heavy load positioned below the girder, suspending the heavy load below the girder.

11. The method of claim 10, wherein there is further included a series of girders with undulating floor decking having sequential upper plateaus and lower valleys sections running cross-wise above the girders and supported by the girders, with the valley sections resting on the upper flanges of the girders and the pleateaus being about just a couple of inches above the girders; and wherein there is included the step in step “b” of:
placing said side-gripping elements on the top flange of a girder between two valleys and below a plateau of the floor decking.

12. The method of claim 10, wherein there is further included:
one or more of the other, innovative, unobvious method steps disclosed in the foregoing specification.

13. A heavy load bearing system using a clamping system for holding up a heavy work piece of at least hundreds of pounds below and from an I-beam type girder having a top, laterally extended flange having side edges, a bottom, laterally extended flange and an intermediate, vertically disposed member forming the “I” of the girder and a longitudinal center-line, comprising:
a drive; and
two, associated, side-gripping elements, at least one of which having a drive engaging mechanism for interfacing with said drive, said two, side-gripping elements being placed on opposite sides of said top flange of the girder, with said drive being extended across and over the top of said girder between and interconnecting said two, side-gripping elements in driving engagement with at least one of said side-gripping elements at said drive engaging mechanism, said drive causing said two side-gripping elements to be drawn together and gripping the side edges of said top flange between them when actuated, the heavy work piece being held up below said bottom flange at least in part by through at least one of said side-gripping elements from said top flange of said girder.

14. The clamp system of claim 13, wherein:
at least one of said side-gripping clamp elements includes an inwardly moveable, supplemental support member moveable into engagement with the intermediate web member of the girder and capable of being locked into its engagement disposition.

15. The clamp system of claim 14, wherein there is a supplemental support member on both of said side-gripping clamp elements, and wherein:
said side-gripping clamp elements, said drive and said supplemental support members from a rectangular, surrounding structure about the top flange of the girder.

16. The clamp system of claim 13, wherein each of said side-gripping clamp elements includes:
a top placeable above the top of the top flange and having a height no more than about two (2″) inches, allowing the clamp system to be used in small compact areas above the girder.

17. The clamp system of claim 16, wherein:
said top of each of said side-gripping clamp has a flat bottom at least at its area in contact with the top of the top flange of the girder providing flat, face-to-face engagement therewith.

18. The clamp system of claim 16, further including:
an attachment selectively attaching a threaded nut to allow only one side to be pulled by the threads of said threaded rod.

19. The clamp system of claim 18, wherein there is further included:
a hex head welded to said attachment for being engaged with a standard socket wrench to allow quick connecting to said threaded rod for rotating it.

20. The clamp system of claim 13, wherein:
the heavy work piece located below the bottom flange of the girder is held up by both of said side-gripping elements from the top flange of the girder; and
wherein there is further included:
two load connection members, one on one of said side-gripping elements and the other on the other of said gripping elements, spaced substantially equally apart on opposite sides of the longitudinal center-line of the girder.

21. A heavy load bearing clamp system for holding up a heavy work piece of at least hundreds of pounds from and below an I-beam type girder having a top, laterally extended flange, a bottom, laterally extended flange and an intermediate, vertically disposed web member forming the “I” of the girder, comprising:
a laterally extended connecting and locking bar having an exterior and end portions and having a series of spaced latching holes at at least its end portions; and
two, associated, side-gripping elements, each of which has a pin engaging mechanism mating with a selected one of said latching holes, said two, side-gripping elements being placeable for sliding, telescoping engagement with the exterior of said bar on opposite sides of a selected one of the flanges of the girder, said bar serving a track way for moving said two side-gripping elements toward one another to grip the side edges of the selected one of the flanges between them, the pin engaging mechanisms serving to then lock the two, side gripping elements to said bar in opposition to one another, the heavy work piece being held up at least in part by the bar and said side-gripping elements from the selected one of the flanges of the girder below the bottom flange of the girder.

22. The clamp system of claim 21, wherein each of said side-gripping clamp elements includes:
a heavy load support plate whose side surfaces are extended “vertically” in a plane parallel to the direction of extension of said bar and has a leading side, and
a laterally extending, orthogonal plate, angled down with respect to the direction of extension of said bar and being fixedly attached to said leading side of said support plate and having a leading edge and a trailing edge, said leading edges of said side-gripping clamp elements contacting the sides of the web member along a straight surface edge while said trailing edges are concurrently contacting the side edges of the selected one of the flanges along a straight surface edge, in or at least near compression.

23. The clamp system of claim 22, wherein:
said side-gripping clamp elements, with their respective leading and trailing edges, and said bar form a rectangular, surrounding structure about the selected one of the flanges of the girder.

24. The clamp system of claim 21, wherein, when the clamp system is attached to the bottom flange of the girder, there is further included:
a centrally located, heavy load support accessory element riding on said bar and located between said side-gripping elements having a heavy load supporting opening through it located directly under the web of the girder and to which is attached a heavy load of several hundred pounds which is supported and carried by said opening.

25. The clamp system of claim 24, wherein:
said opening is an extended opening, extended in the “vertical” longitudinal direction.

26. The clamp system of claim 24, wherein:
said two, side-engaging elements and the bar can be alternatively attached to either the top flange or the bottom flange.

27. A method of lifting a heavy work piece located below an I-beam girder having a top flange member, a bottom flange member and an intermediate web member between them with the girder having a longitudinal center-line, comprising the following steps:
a) providing a clamp system (110) for a selected one of the flange members (101/102) of the I-beam type girder (100), with the clamp system including two, side gripping clamp elements (120/130) having side bearing areas (128/138) for engaging the central web and the side edges of the selected one of the flange members of the girder, and a laterally extended, solid, connecting and locking bar(150) extended between them in potential pin/hole engagement with both of the side-gripping elements;
(b) positioning the two, side gripping elements on opposite sides of the top girder flange with the bar then positioned between them and located over and across the selected girder flange, with both gripping element initially freely riding on the bar which then serves as a track; and
(c) moving the two, side-gripping elements toward each other on the bar, until their leading and trailing edges approach and then contact the central web member and the sides of the selected flange member and locking the two, side-gripping elements to the bar using a pin/hole engagement between each one of them and the bar when the side-gripping elements are in or at least near contact with the selected flange member; and
(d) attaching a heavy load (200) weighing at least hundreds of pounds by at least one set of rigging with the heavy load positioned below the girder, suspending the heavy load below the girder.

28. The method of claim 27, wherein the selected one of the flange members is the top flange and step “d” comprises the steps of:
attaching a heavy load (200) weighing at least hundreds of pounds by at least one set of rigging members (210) on both sides of the girder, one set on each side of the girder, with one attached to one of said side gripping elements and the other attached to the other of said side-gripping elements at points substantially equally spaced from the longitudinal center-line of the girder with the heavy load positioned below the girder, suspending the heavy load below the girder.

29. The method of claim 27, wherein the selected one of the flange members is the bottom flange, and there is further included a heavy load supporting, downwardly extending, accessory element, and wherein in connection with steps “b” and “c” there is included the steps of:
positioning the accessory element on the bar between the two, side-engaging elements and directly below the central web member of the girder, and locking the side-engaging members to the bar and the girder, locking the accessory element between the bottom surface of the bottom flange member and the upper surface of the bar; and
wherein step “d” comprises the steps of:
attaching a heavy load (200) weighing at least hundreds of pounds by at least one set of rigging to the centrally located, downwardly extending accessory element directly below the longitudinal center-line of the girder with the heavy load positioned below the girder, suspending the heavy load below the girder.
